(19) United States
(12) Patent Application Publication
(10) Pub. No.: US 2002/0069077 A1
(43) Pub. Date: Jun. 6, 2002

(54) Computerized system for customizing and managing benefits

(75) Inventors: John T. Brophy, Weston, CT (US); Ann Lyndon, Stamford, CT (US); A. Michael Foley, Omaha, NE (US); Robert E. Smith, Granby, CT (US); Philip R. Crevier, Newtown, CT (US)

Correspondence Address: MERCHANT & GOULD PC, P.O. BOX 2903, MINNEAPOLIS, MN, 55402-0903, US

(73) Assignee: Westport Benefits, L.L.C., Westport, CT

(21) Appl. No.: 09/816,541

(22) Filed: Mar. 23, 2001

Related U.S. Application Data
(63) Continuation of application No. 09/081,234, filed on May 19, 1998, now abandoned.
(60) Provisional application No. 60/048,705, filed on May 19, 1997.

(51) Int. Cl. G06F 17/60

(52) U.S. Cl. 705/1

(57) ABSTRACT

The present invention is directed to a computer system for administering employee benefits. The computer system comprises a first tier. The first tier includes a plurality of users. At least one user is a workstation having a processor and memory. At least one other user is a system processing means. The workstation is configured for inputting rules into the computer system. The rules are for controlling the computer system. The system processing means is configured to generate and execute transactions based upon the rules. A second tier includes memory configured to store the rules. The rules are organized into tables within the memory of the second tier. A third tier includes memory configured to store benefit data. The benefit data is organized into tables in the third tier memory. The benefit data can be manipulated only by the system processing means executing the rule-based transactions.

### REFERENCE TO CO-PENDING APPLICATIONS

This application claims priority to U.S. Provisional Application Serial No. 60/048,705, which was filed on May 19, 1997 and entitled Computerized System for Customizing and Managing Insurance, the disclosure of which is hereby incorporated by reference.

### TECHNICAL FIELD

The present invention relates to a computerized system, and more particularly, to a computerized system for customizing and managing benefits such as insurance.

### BACKGROUND

In the current economy, employers cannot remain competitive and continue to pay for all of the benefits wanted by employees. The ever increasing cost of benefits is compounded by reductions in available funds. The age of unbounded employer paternalism has come and gone.

Furthermore, most employers had group benefit plans designed to meet the needs of all employees. The problem is that employers have a diverse group of employees having a wide range of different needs. For example, an employer typically has older employees near retirement, middle aged employees with families, single employees, and younger employees that are just starting their careers. As a result, an employer's group benefits plan needs to include a wide variety of insurance and other benefits in order to meet the needs of all of its employees. The old model of group plans is inefficient and often more expensive than necessary. The employer would enroll each employee in the available benefits similarly, even through the employee's needs were not the same.

Increasing benefit costs and reduced available funding have forced employers to shift responsibility for retirement planning and insurance benefits to employees. Employees are offered choices today that allow them to select benefits appropriate to their own situations, but are required to pay for all or part of the costs of the benefits. This introduction of voluntary employee paid benefit plans has resulted in a blurring of the delineation between individual and group products.

As costs have been shifted to employees, employers have endeavored to improve their voluntary benefit packages by incorporating more benefits, including non-traditional insurance benefits and non-insurance benefits. Examples of such benefits that are being offered by employers through payroll deduction today include pre-paid legal services, mortgage refinancing, auto and homeowners insurance, and “pricing club” type benefits such as discount computers.

Additionally, employers traditionally maintained information about the employee benefit plans, while insurers/administrators maintained information about insurance offered in connection with these plans. Employers' human resource staffs typically answered employees questions about benefits. The same costs and funding factors have left employers increasingly unwilling to bear the service and record keeping burden.

There is also difficulty with current payroll systems because of the increasing number and variety of voluntary benefits being paid for by employees through payroll deduction. In order to add a benefit, a line must be added to the employee's pay stub. These lines are commonly called slots and there are a limited number of such slots. The employer can not offer any additional employee paid benefits after the last slot is used.

Computerized systems for administering group benefit plans based on the traditional model are not sufficiently flexible to meet the requirements of the changing benefits marketplace. Such systems maintain information about the insurance products, but not about the employee's benefit plan/package. Nor do such systems anticipate the inclusion of non-insurance benefits. The design of the records used by such systems is typically too tailored to the specific insurance products and cannot incorporate benefit plan data. Whenever the group insurance products or the group benefit plans are modified, the computer code usually needs to be modified, or even rewritten. Modifying the record design and the computer code is expensive, time consuming, and increases the likelihood that there will be errors in the system. There is also a negative effect on the delivery of services. The time frame for implementing changes in the employer's benefit plan and the employees' choices are determined by the marketplace; if system modifications are required and cannot be done in time, the service provider fails in performance to both the employer and the employee.

Furthermore, traditional group insurance products did not require the extensive individual record keeping needed for voluntary payroll deduction products. Storing customized records for every employee and every type of benefit requires a tremendous amount of data storage. The amount of required storage is compounded when it is necessary to maintain a historical record of various transactions. Maintaining this volume of storage is expensive and places a burden on the computer system used to administer the benefits.

Therefore, there is a need for a system that more efficiently manages the creation, maintenance, and archiving of benefit data. There is a further need for a system of administering insurance products, non-insurance products, and benefit plans within the same system. There is also a need for a system that is customizable without extensive reprogramming. There is a need for a system that permits the administrator to choose from a wide variety of benefit options in recording the specific employer's benefit package and its employees' choices, without requiring modification of the system's record designs. There is a need for consolidating a number of payroll deduction amounts for a variety of benefits to reduce the number of slots needed on a pay stub. There is another need for a system that maintains information only at the level at which it is actually needed, allowing the administrator to select this level differently for different employer groups, for different benefit packages within an employer group, and for different classes of information within a package. There is a need for a system that minimizes the need to modify program code to accommodate modifications or changes to benefit plans. Finally, there is a need for a computer system that permits selection of methods for calculating and processing benefits from a wide variety of available methods.

### SUMMARY

The present invention is directed to a computer system for administering employee benefits. The computer system comprises a first tier. The first tier includes a plurality of users. At least one user is a workstation having a processor and memory. At least one other user is a system processing means. The workstation is configured for inputting rules into the computer system. The rules are for controlling the computer system. The system processing means is configured to generate and execute transactions based upon the rules. A second tier includes memory configured to store the rules. The rules are organized into tables within the memory of the second tier. A third tier includes memory configured to store benefit data. The benefit data is organized into tables in the third tier memory. The benefit data can be manipulated only by the system processing means executing the rule-based transactions.

### DESCRIPTION OF THE DRAWINGS

FIG. 1 is a block diagram illustrating the architecture of a computer system that embodies the present invention;

FIG. 2 list various classifications of database tables included in the computer system of FIG. 1;

FIG. 3 is a chart illustrating the process of generating and automatically executing a transaction;

FIG. 4 is chart illustrating the process of generating and executing transaction records, master records, and trailer records;

FIGS. 5-13 illustrate various tables that are used in the computer system of FIG. 1 and the processes of FIGS. 2 and 3;

FIG. 14 illustrates a user interface for a parsing engine that is used in the computer system of FIG. 1;

FIG. 15 is a flowchart illustrating operation of the parsing engine that is used in the computer system of FIG. 1; and

FIG. 16 illustrates operation of the reporting engine that is used in the computer system of FIG. 1.

### DETAILED DESCRIPTION

A preferred embodiment as well as several alternative embodiments of the invention will be described in detail with reference to the drawings. Reference to these embodiments does not limit the scope of the invention, which will be limited only by the scope of the claims appended at the end of this description.

In general terms, one embodiment of the present invention is directed to a computer system having multiple tiers that provides a central location for rules that define and control operation of the system. A daily cycle program accomplishes tasks by creating and executing transactions in accordance with these rules, and the processing of information within the system is permitted in no other way.

This configuration has several advantages including flexibility, efficiency, consistency, and safety of operation. The design and scope of the rules provide flexibility and efficiency so that a wide variety of business functions can be accommodated by simply modifying the rules, which are stored in tables, without requiring any modification of programs. The types and functions of the rules are described below in more detail.

The system's programs are of a modular and extensible design and are constructed expressly to operate by executing functions triggered by reading the rules, which are referenced through transactions. Thus, operation of the system can be easily and efficiently modified by modifying the rules. If a rule is added that is of a type a particular program did not previously recognize, the only change required to the program is the addition of a clause to an existing set of similar clauses. If a rule is modified to a form a program did not previously recognize, only the program clause involving that particular rule is changed. Each clause addition or modification leaves existing clauses intact, which reduces exposure to system errors introduced inadvertently during program maintenance. This design minimizes the extent, and consequently the time and cost, of regression testing. Furthermore, the system can be easily modified to accommodate a wide variety of insurance and other benefit products for which funds are invested in a variety of ways, including general funds for which the rate of interest credited varies depending on the date money was deposited, and unitized funds of the mutual fund type.

Further, program clauses (functions and routines) are stored in a library of clauses. An advantage of storing clauses in a library is that clauses used by more than one of the system's programs are not duplicated within the system. If modification of a clause is required, it needs to be modified only in one place.

As will become apparent below, a related advantage is the ease with which a computer system that embodies the present invention can be adapted to accommodate different types of benefits that the system did not previously administer and that require the creation of new tables for benefit data in the third tier. This ease results from the rule and transactional basis of the system, the ease with which program clauses can be edited or added, the ease with which rules can be modified, and the ease with which data tables can be created and structured.

Yet another advantage is that the system reduces the burden placed on the individual workstations. These workstations are not required to contain all of the tables and rules for every possible calculation or transaction. Rather, the workstations require only those rules and data required for the particular task at hand, and those only temporarily. Each workstation includes a portion of the memory reserved for temporarily caching rules, and thus not as much memory is required. Furthermore, the workstation can operate faster.

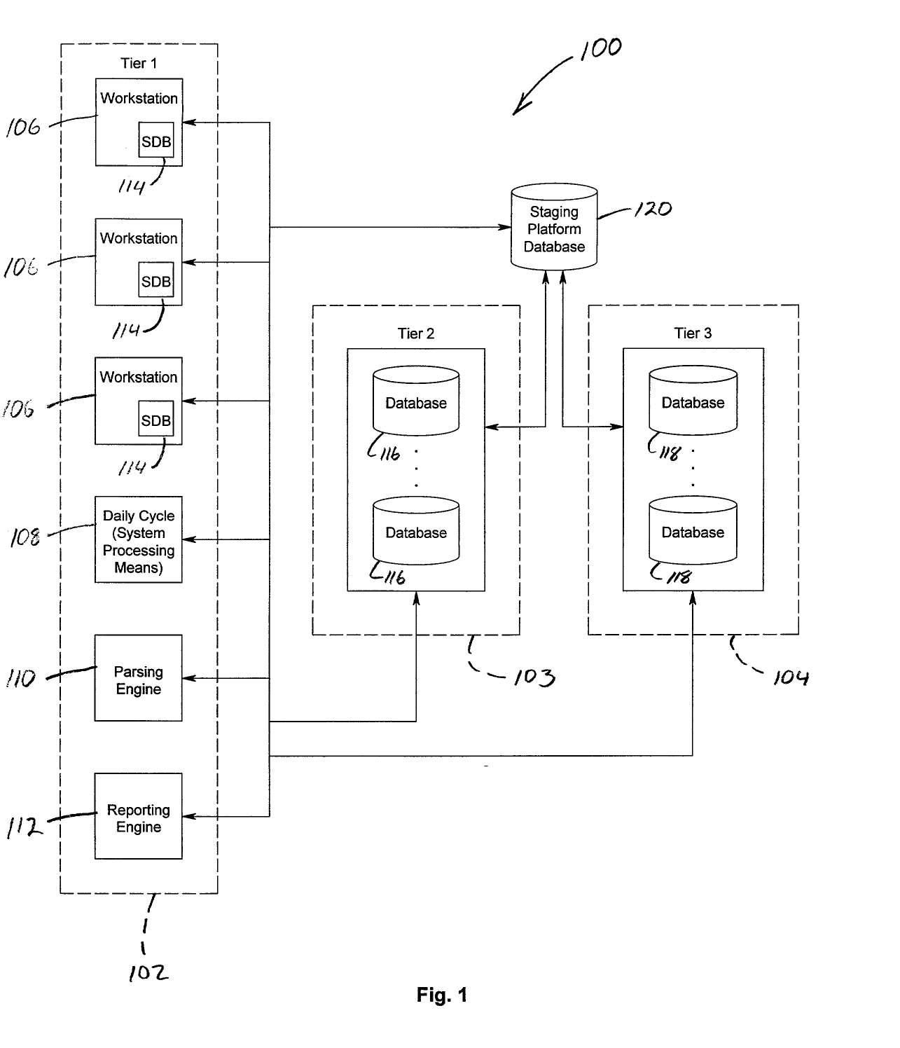

Referring now to the drawings, FIG. 1 illustrates a computer system, generally shown as 100. The computer system includes a first tier 102, a second tier 103, and a third tier 104, each of which are described below in more detail. The computer system 100 is configured and arranged to generate and execute various types of transactions for administering benefits. Each transaction is an event that accepts input, invokes a process, creates or modifies a record, or produces an output. Operation of the computer system 100 is based on tables. Each table is a collection of data or rules uniquely identified by some type of label. The tables are organized into rows, each row forming a separate record. Each record has a plurality of fields or cells that contain the label, a rule, or benefit data.

The first tier 102 is formed from a plurality of users that access the second tier to perform tasks involving information stored in the third tier. Various users within the first tier 102 can include workstation 106, the daily cycle program 108, a parsing engine 110, and a reporting engine 112. In one possible embodiment, the workstations 106 are formed from personal computers operating a Pentium II™ microprocessor running at 333 MHz or higher, a data communications band of at least 100 Mips, and 128 Mbytes of RAM. Each workstation 106 is linked to the second and third tiers 103 and 104 by a local area network (LAN) operating in an Ethernet topology. In alternative embodiments, however, the workstations 106 and servers of the second and third tiers 103 and 104 could be in data communication through other means such as a wide-area network or an intranet. In these configurations, the workstations 106 of the first tier 102, the second tier 103, and the third tier 104 can be located at separate locations. For example, a first tier workstation 106 used by an operator to respond to customer inquiries could be located at a different site from that at which the second tier rules database is located.

Each workstation 106 includes a scratch database 114, which is a portion of the memory on the workstation 106 reserved for caching rules. The scratch database 114 is created with Microsoft Access for Windows 95™. Processing for creating, using, and destroying this transient database is programmed in Microsoft Visual BASIC™. The scratch database 114 stores the rules that are required for a particular session, which is a period devoted to performing particular tasks. After the session is complete, daily cycle 108 clears the scratch database 114 so that the workstation memory is free for other uses. The type of rules that are cached in the scratch database 114 include data entry rules, data inquiry rules, and input validation rules.

In operation, when a workstation 106 is performing a task that requires a rule, the entire table in which the required rule is located is copied to the scratch database 114. Copying the required rules tables to the scratch database 114 eliminates redundant data communications and reduces the burden placed on the workstation 106, the second tier 103, and the communication link between the workstation 106 and the second tier 103. Eliminating redundant data communication is especially important when there are many workstations 106 attempting to access rules in the second tier 103, which would tend to degrade performance of the computer system 100.

An example of how the scratch database 114 reduces the burden placed on the computer system 100 is in entering data about many different employees in which every record for the employee includes a state code that identifies the employee's residence. Every time a state code is entered, that code is compared to rules in a data validation table. Each rule in the data validation table for verifying state codes corresponds to the official recognized code for a state. An example is IN for Indiana. If 100 records are entered, the workstation 106 ordinarily would need to access the second tier 103 100-times to validate the state codes for each record. By storing the validation table for state codes in the scratch database 114, the workstation 106 needs to access the second tier 103 only once to verify the state codes. The result is a 100-fold reduction in the data communication between the workstation 106 and the second tier 103.

Daily cycle 108, which is programmed in a processor and forms a system processing means, is a batch processor comprised of Visual BASIC program routines and SQL Server stored procedures. It includes an auto-scheduler process, which is described below in more detail. Unlike other systems in which processors are generally launched by workstation operators in the first tier 102, daily cycle 108 operates as a user within the first tier 102. Daily cycle 108 accesses database tables in the second tier 103 that contain rules and updates tables in the third tier 104 as described below in more detail. Through daily cycle 108, the computer system 100 becomes a user, or client, of itself. That is, daily cycle 108 controls and regulates the generation and execution of transactions. In turn, through these transactions that it generates and executes, daily cycle 108 controls manipulation of the data included in the third tier 104.

The second tier 103 is formed in at least one server that operates on a Pentium II™ microprocessor running at 333 MHz or higher, a data communications band of at least 100 Mips, and 128 Mbytes of RAM. The second tier 103 also includes a 4 gig RAID device. In alternative embodiments, the second tier is formed from a mainframe computer, micro-computer, or other computing apparatus. The second tier 103 stores the rules in a database 116 and organizes those rules in a plurality of tables. The server database engine is Microsoft SQL Server™, while the front end or user interface for the database is programmed with Microsoft Visual BASIC™.

The second tier database 116 includes tables for rules and raw data. Raw data tables, a class of rules tables, contain data from external sources that is specific to a product and/or customer. In one possible embodiment, the tables for rules and raw data are stored in a single database. In other embodiments, however, the tables are divided between multiple databases, which may provide faster access time. In yet another possible embodiment, multiple databases in the second tier 103 could be allocated between multiple servers.

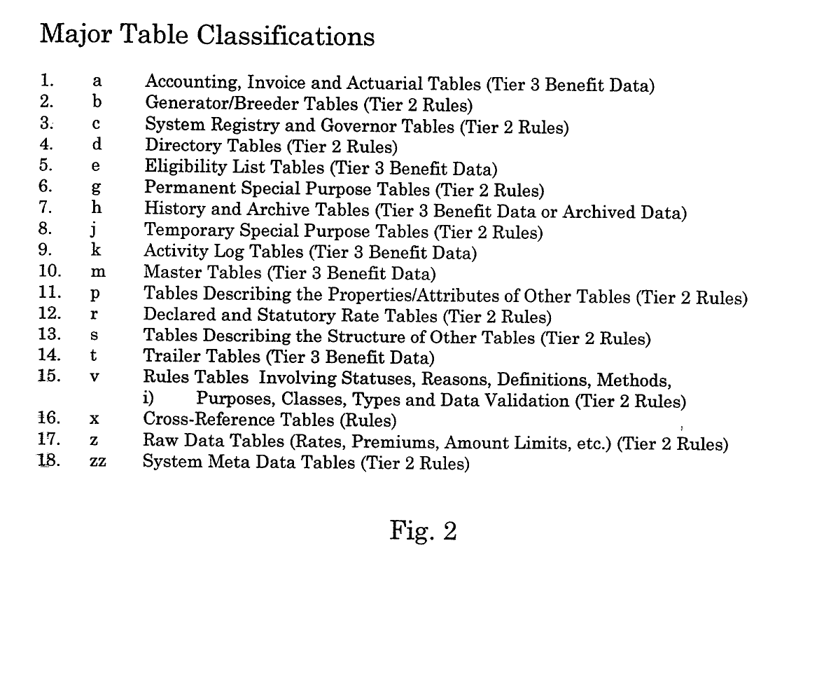

The rules tables contain rules, some of which provide parameters used by daily cycle 108 to determine how a transaction will be generated and will execute. Other rules tables perform other functions. Examples of rules tables include breeder tables, accounting and actuarial tables, system registry tables, rate tables, cross-reference tables, data validation tables, structure tables, data property and attribute tables, and directory tables. A listing of the various classes of tables is set forth in FIG. 2. Breeder tables are rules tables that identify and contain information used by daily cycle 108 to create the various transactions for execution by the computer system 100. Information in a schedule breeder table includes the next due date for the transaction, the number of days in advance of the due date to create the transaction, the number of days in advance of the due date to move the transaction from a scheduled to a pending status, and the final date for executing the transaction. Additional information is included in subordinate breeder tables, such as an invoice breeder.

Accounting and actuarial tables contain tax information, reserves and invoice records. System registry tables contain information related to security such as which users at the first tier 102 can access the system and what type of information they can access, a registry of transactions, a registry of reports, database structure versioning, and key counters for various tables. Rate tables contain interest rates, unit values, and tax rates. Cross-reference tables contain information for relating or translating one type of information to another type of information. For example, a cross-reference table relates policies to insureds. Another cross-reference table relates a parent transaction to various child transactions, and another relates transactions to the subordinate breeder tables required to generate them.

Data validation tables contain a variety of information including the classification of various transactions such as benefit, income and change; the type of information including insurance coverage types, interest types, rate types and beneficiary types; state codes, nominatives of address; and language codes. Purpose, status and reason tables contain, for example, codes for identifying the status of a transaction, reasons for suspending a transaction (suspension of a transaction is discussed below in more detail), an employee's employment status, state licensing status of products or producers, the purpose for which a particular address is used, and the status of an insurance policy. Methods tables describe the formulas for various calculations, rounding methods, methods of changing rates, payroll deduction methods, etc. Directory tables identify the location of records in other tables and the location of tables within multiple databases.

System meta data tables contain information that identifies all of the other tables within the computer system, the fields within each of these tables, the properties of each of the fields, and the length of the tables. Structure tables describe the structure of other tables stored within the second and third tiers 103 and 104. This information is used, for example, for formatting information that is being imported to or exported from the computer system 100.

Properties and attribute tables describe the contents of other tables. For example, such a table might contain information that dictates whether a rate table contains rates that vary by gender or by whether an insured is a smoker. The tables also might identify age ranges for assigning a premium, such as 50-54, 45-49, 40-44, or durations for applying an expense charge, such as year 1, years 2-5, etc.

Raw data tables are lookup tables that contain data from external sources that are specific, for example, to a product and/or customer. Examples include data relating to mortality, rates, premiums, expense rates, reinsurance rates, and amount limits. The data property and attribute tables are used in conjunction with the raw data tables to define which record to read within the raw data table and how to read the data in that record. For example, a selected record in a data property table will dictate the record to read in the raw data tables for premiums and then define that premium as being applicable for female nonsmokers in the age range of 50-54.

The third tier 104 is also formed by a server that is similar to the server for the second tier 103 and include at least one database 118. In one possible embodiment, the second and third tiers 103 and 104 are formed from separate servers. In yet other possible embodiments, the computer system 100 can have any other number of servers, and each server may include any number of databases. One extreme is a series of many servers, one server (or more) for each class of rule. Another example is keeping historical benefits data on a separate server. At the other extreme, the entire system 100 could be deployed on a standalone machine. The actual deployment topology does not affect the conceptual organization of separate components of the computer system 100 being organized into tiers.

Data tables in the third tier 104 contain information or benefit data related to various benefits that are administered using the computer system 100. For example, the tables will contain information about benefit and policy holders, who may be employers or employees; insurance companies that have their policies administered on the computer system; demographic information about the insured; billing records; and financial information such as the policy cash values and cash reserves. Tables in the third tier 104 contain benefit data being administered in accordance with the rules given in the second tier 103.

These data tables are organized into master and trailer tables. A master table is a table that contains a higher level of information than a trailer table. In this configuration, the tables have a one to many relationship. One master table is related to many trailer tables. For example, a master table might contain information identifying a policy while its related trailer tables contain information such as the death benefit of the policy, the premiums paid for the policy, the cash value for the policy, a record of cash paid out under the policy, a record of events that caused a cash pay out, or other details related to the policy. Additionally, master tables may be related to one another. If two master tables are related to one another, that relationship is defined by a rule in a cross-reference table in the second tier. Trailer tables may also be related to master tables or to each other by cross-reference tables.

The third tier 104 also has a set of transaction tables that form a queue for holding transactions. The form of all these transaction tables is identical. The transaction tables include a scheduled table, a pending table, an awaiting table, a suspended table, and a history table. The scheduled table or queue holds transactions that have been scheduled, perhaps well in advance of their scheduled execution date. The pending table or queue holds transactions that are near to or have reached their execution dates. The awaiting table or queue holds one of two types of transactions. One type of transaction held in the awaiting queue is one that requires confirmation, such as security transactions awaiting confirmation that an actual trade has been completed. The other type of transaction held in the awaiting queue is one that requires reconciliation such as a premium billing transaction. The suspense queue holds transactions that have encountered some type of problem in editing or processing that requires a resolution.

The transaction history table holds transactions that have been successfully processed to completion and transactions that have been voided. Transactions can be stored at various levels of detail, depending on the rules applying to the particular case, where a case is identified as a set of transaction records having the same key identification elements. For example, for one employer/case for a transaction that generated billing invoice records, the transaction saved in the history table might contain only a high level of information such as the aggregate amount billed to an employer and a corresponding invoice number, and exclude the detailed information such as the individual charges that were summed into the aggregate amount billed. For a different employer, a detailed transaction record might be retained in history for each individual amount billed. The level of detail that is retained in a transaction historical record is defined by rules that can be varied by case. Another example is life insurance claims, for which the historical record is usually kept at the individual level.

Daily cycle 108 periodically scans the auto-scheduler to determine which automatically scheduled transactions are due to be scheduled, scans the queue to determine whether transactions need to be transferred from one state to the next such as from scheduled to pending, and scans other tables to determine what rules and raw data are needed to execute the transaction. One-time transactions are entered by setting the beginning and final date for the transaction to be on the same day. One-time transactions also may be entered into a staging platform database 120 from a workstation 106. These transactions may then be submitted to daily cycle 108 to be edited and placed in the scheduled transactions queue. The staging platform database 120 is described below. Examples of one-time transactions that might be entered include claim benefit payments and payment of the cash value of an account or life-insurance policy. This process is described below in further detail.

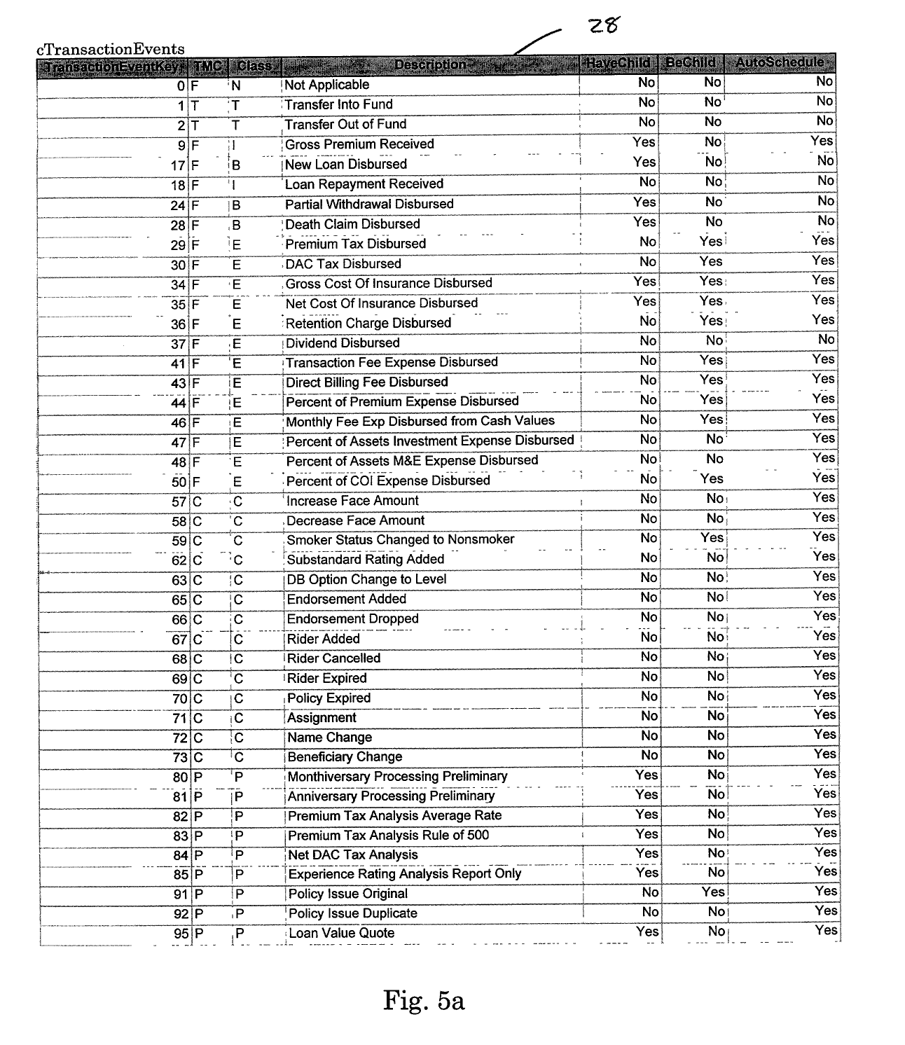

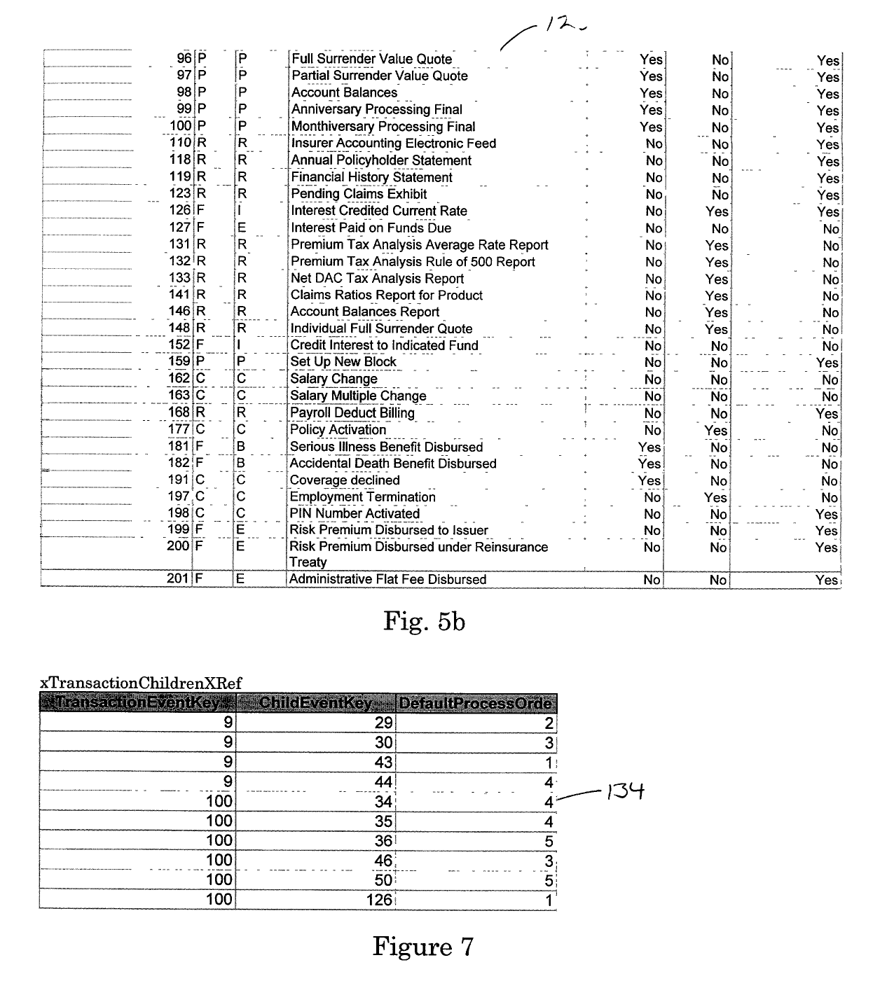

History tables in the third tier 104 include on-line history tables and archive history tables. The history tables contain historical records of information in the second tier and third tier tables that has been changed. Some second tier 103 and all third tier 104 tables have associated history tables. Once data is entered into the system, it is never deleted. If a record is changed, the old record is placed in the associated history table and the changed record resides in the appropriate current table. If data should never have been entered, it can only be voided, with the void record placed in history. Thus the computer system 100 maintains a complete audit trail of all activity. Because second tier rules tables control operation of the system 100, the existing records in many such tables cannot be changed, although new records can be added to the tables. Because changes are not permitted, these second tier 103 tables do not have corresponding history tables. An example of a second tier 103 table that cannot be changed is the transaction events table, which is represented in FIG. 5.

History tables in the third tier 104 containing historical information from the master and trailer tables provide an on-line source of information. Rules from the second tier 103 define how and when information from the on-line history tables is moved to an archival database. A rule can define that only information from a particular table containing a particular identifying key is archived from an the on-line history table at a given time, rather than archiving all of the information from the table. Another rule can define that records from many tables containing a particular identifying key are archived from on-line history tables at a given time. An example of an identifying key might be the employer code assigned to the information relating to a particular employer. Additionally, the rules define how often information from the on-line history tables is archived to archive history tables and where the archive history tables are stored.

The computer system 100 is also programmed to archive information from archival databases to off-line history tables, typically stored on a storage medium such as a recordable CD. Again, the rules define how and when information is moved to the off-line history tables. Information can be archived to the off-line history tables from the on-line history tables or from the archival history tables. Additionally, the computer system 100 sets a flag and sends a message to the system administrator when it is time to archive data to the off-line history tables so that the administrator can load a recordable CD into a drive. The recordable drive is installed in one of the workstations 106. If a request is made to retrieve data that has been archived off-line, a message that includes the specific location of the requested information is sent to the inquirer. This message can be forwarded to the system administrator so that the CD or other medium can be loaded into the system 100.

The staging platform database 120 is in data communication with the first, second, and third tiers 102, 103, and 104. The staging platform database 120 includes a copy of all the tables from the third tier 104, but without the data loaded in those tables. A user, including a workstation 106 being controlled by an operator can access data that is input into tables within the staging platform database 120. The staging platform database 120 has several functions and advantages. For example, when a user adds a rule to the second tier 103, operation of the rule can be tested by using test data within the staging platform database 120. In another example, if data being input to the system needs to be manually edited or massaged, it can be first input to the staging platform database 120. After editing and massaging the data is complete, a transaction can be generated and executed by the daily cycle 108 to submit the data into the third tier. The transaction includes rules to validate the data 104.

Because the staging of data to production is accomplished by a transaction, a permanent record of the data's origin is retained in the transaction history table. Also, because the staging platform database 120 is of identical structure as the production data, all user manipulation is accomplished through the same routines as first tier workstations 106 as well as daily cycle 108. All staging activity, therefore, contains a trail of the evolution of the data, as well as a trail of the various tests performed on it. Rather than being destroyed, this data is archived off line when it is staged, and a record of its location is retained in the production transaction record that performed the migration from staging to production.

Additionally, the computer system 100 accommodates special purpose tables, some of which are transient in nature. Examples of applications for temporary and special purpose tables include census information and information related to an audit. These temporary and special purpose tables may reside in either the second or third tier 103 or 104, or in the staging platform database 120, depending on the context of the application. An example of a second tier deployment is a table containing a list of payroll dates. This type of data is specialized, but not transient. While it is a rules table, it is typically modified more frequently than other classes of rules tables.

An example of third tier deployment is census data submitted to production for audit. While such temporary tables are transient in nature, any data of this type that is submitted to the third tier 104 is not destroyed upon the end of its usefulness, but rather the data is archived according to rules defined by the initiator of the application. An example of staging platform database deployment is initial census data from a client that needs to be parsed and verified.

An advantage of the present system is that no data, whether a rule or benefit data is ever deleted. Outdated and even incorrect data is archived in history tables. Thus for example, if a successful transaction occurs that changes third tier data, the transaction is moved to transaction history, the resulting new benefit data is updated in the production tables, and the previous benefit data is moved to on-line history tables. If a completely erroneous transaction occurs, the transaction is voided and is archived. In this manner, a complete audit trail is created and it is possible to perform a complete historical accounting of all the policies and benefits that are administered using the computer system 100.

The present system thus greatly enhances the process of undoing and redoing processing, which is virtually impossible in many systems, or if possible, very expensive and time consuming. For example, an increase in the amount of insurance for a policy might be incorrectly reported by an external source, resulting in subsequent premium calculations being incorrect. Collection of the incorrect premium might result in the policy cash value being incorrect, which results in cost of insurance deductions and interest credits being incorrect. Thus many transactions and many generations of data from many third tier benefit data tables might be affected. Third tier tables involved in the above example include, a death benefits trailer, a premium trailer, an insurance costs trailer, and a general funds trailer. Trailer tables in the third tier 104 hold benefits information that changes with some frequency. Information in these records and their historical counterparts would be incorrect for each processing date after the original error.

Once the error is identified, a correcting transaction that changes the original amount is created with appropriate “as of” date information. Daily cycle 108 then performs an “undo/redo” process. Each transaction subsequently performed is identified and voided, with a corresponding new transaction being scheduled. The records in the current third tier benefit data tables involved are voided and moved to the corresponding history tables. Any incorrect records in the history tables, are also voided.

The new corrected transactions are then processed to correctly update the third tier tables, creating new records in the current benefit data tables. New records are created in the history tables for processing periods between the date of the original error and the processing period just prior to the current one. Entirely new transactions also might be created as a part of this process. In the above example, a premium refund transaction and an interest due on funds transaction might be created and processed.

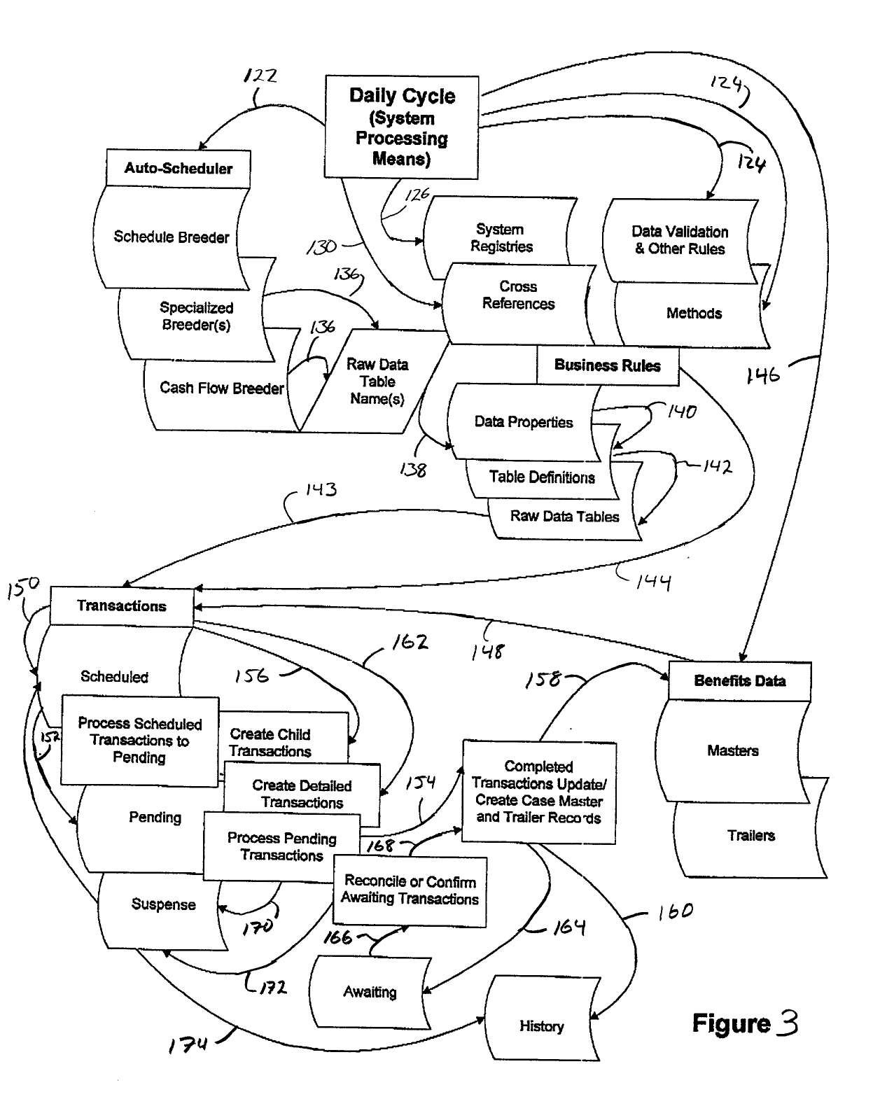

The process of generating and executing automatically scheduled transactions is illustrated in FIG. 3. Such automatically scheduled transactions include transactions that occur on a periodic basis such as billing premiums. Automatically scheduled transactions can also serve as an automated tickler system so that future events that have a predetermined date are automatically generated and processed. Each automatically scheduled transaction is a record that contains the information required to process the transaction. The record is created by selecting information from a series of tables. In this manner each record can be tailored so that it contains the required amount of information.

The level at which the records are maintained is also selected. Levels include the total aggregate level, intermediate aggregate levels, and the individual level. For example, interest might be credited to the cash values of an entire group of policies on a particular date. If the total aggregate level were chosen, only one transaction containing the total amount of interest credited to all the policies would be maintained. If the intermediate level “By State” were chosen, one transaction for each state, containing the amount of interest credited to all policies issued in that state, would be maintained. If the detail level were chosen, an individual transaction for each policy would be maintained. Assuming a set of 5,000 policies were being processed, the number of transactions maintained would be 1 in the first case, around 50 in the second case and 5,000 in the third case. Thus, the ability to choose the level at which information is maintained saves storage memory and processing time because there is no need to maintain unnecessary records.

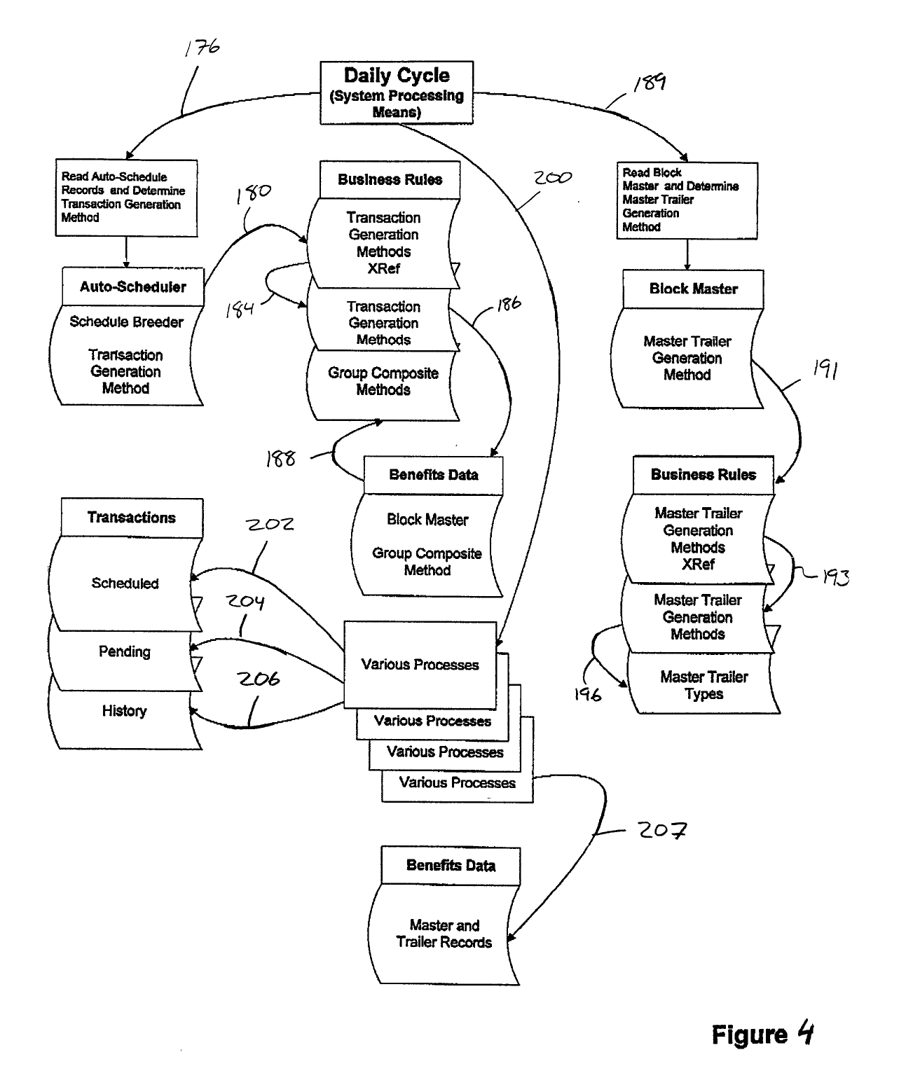

In operation, the auto-scheduler, a part of the daily cycle 108, scans the schedule breeder table to determine whether any transactions need to be bred (generated). Step 122. The schedule breeder contains high level information/rules about the transaction. Its form is the same for all transactions. Subordinate specialized breeder tables, the form of which varies by class of transaction, provide additional detailed parameters for transactions. Examples include a cash flow breeder and a mortality breeder. These specialized breeders may be used at the time of scheduling or further downstream in the process. Rules that are referenced in the schedule breeder determine when a specialized breeder is invoked. For those transactions that are scheduled to be generated, daily cycle 108 reads the various rules to determine the level at which the transaction should be created. Step 124. The creation of transactions is discussed in more detail below with reference to FIG. 4.

Daily cycle 108 also scans the tables for rules to pre-fill data into the transactions. Pre-filling data occurs when the auto-scheduler detects a date and time corresponding to date/time values in the schedule breeder and in accordance with rules referenced in the schedule breeder. Daily cycle 108 also reads the system registry table cTransactionEvents 128 to determine critical information about the particular transaction that is being created. Step 126. Some representative portions of the cTransactionEvents table 128 are shown in FIG. 5. The full table contains a register of all the transactions the computer system 100 knows how to process.

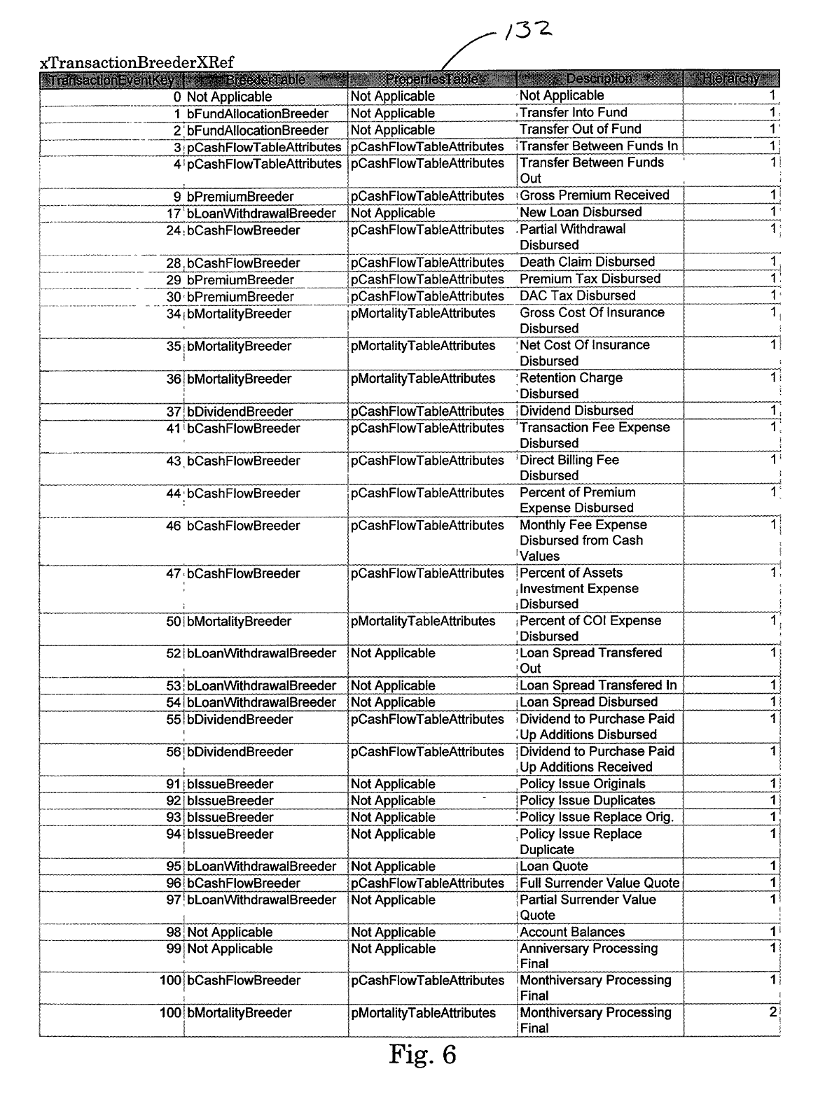

Another task performed by daily cycle 108, step 130, is reading the cross-reference tables to determine a variety of relationships. One relationship that daily cycle 108 determines from the cross-reference tables is the relationship between the transaction being generated and the breeder tables. Some representative portions of this table are shown in FIG. 6, which illustrates a table entitled xTransactionBreederXRef 132. Another relationship determined by daily cycle is the relationship between parent and child transactions and the relationship between peer to peer transactions. Some representative portions of this table are shown in FIG. 7 in a table entitled xTransactionChildrenXRef 134.

A child transaction is one that is subordinate to another transaction, its parent. An example is a state tax levied on insurance premium payments, the premium income transaction being the parent and the tax expense transaction being its child. Because information used in processing a transaction, such as a state tax rate, may change from time to time, child transactions are usually set to be generated as late as possible in the process. This timing renders it less likely that such information has changed between the time the transaction is created and the time it is executed. The computer system 100 is thus more efficient in that fewer transactions have to be undone and redone due to such changes.

Yet another relationship that is determined by daily cycle 108 is the relationship between accounts when funds being applied are to be allocated amongst such accounts. These allocations can vary by purpose, ensuring the correct allocation for the particular transaction. For example, funds might be applied (allocated) differently for a premium receipt transaction than for a claim payment transaction.

The names of the raw data tables that are required to generate the transaction are read from the transaction's record in the appropriate breeder table, step 136, and the data properties of the raw data tables are defined by the rules, step 138. The raw data tables follow the table definitions that are provided by the rules stored in meta data tables. Step 140. As described above, meta data tables contain data describing other data, for example, data that defines the other data's format and nature (e.g. contents text, decimal number, long integer).

The raw data tables that contain specific information are then read at the point designated by the rules. Step 142. Examples of specific information include cost of insurance rates, expenses, and underwriting limits. Raw data is read at one of several possible points during generation or execution of the transaction. Step 143. These points include when a scheduled transaction is created, when a transaction is moved from the scheduled queue to pending queue, and when a pending transaction is processed. The point during generation of the transaction that raw data is read depends on the method of processing the transaction, which is dictated by the rules in the transaction's record set.

The rules determine what information is required to be incorporated into the transaction. Step 144. After the required information is identified, daily cycle 108 scans the master and trailer tables, step 146, and reads the required information into the transaction, step 148. The newly generated transaction is placed into the schedule queue. Step 150. The scheduled transaction includes information identifying the date when the schedule transaction should be moved into the pending queue and when the pending transaction should be executed. Daily cycle 108 scans the transactions in the scheduled queue and moves the transaction into the pending queue on the appropriate date. Step 152. Daily cycle 108 also scans the pending transactions and executes the pending transactions at the time indicated by the date stored in the transaction. Step 154.

Additionally, child transactions are created at a point defined by the rules associated with the parent transaction. Step 156. Times when a child transaction can be created include, when the transaction is placed in the scheduled queue, when the transaction is moved from the scheduled queue to the pending queue, or when the transaction is executed. During execution of a transaction, master and trailer data is generated and stored in the master and trailer tables. Step 158. The rules and data used in successfully completed transactions are archived in the transaction history table. Step 160.

In addition to the processing of scheduled transactions as discussed above, individual detailed transactions are spawned from group-level transactions if and when appropriate based upon the rules. Step 162. Group-level or zero-level transactions contain transactional information that applies across an entire group of records. The term “zero-level” stems from the use of the fictitious policy number “0” in such records (those applying to insurance transactions) to indicate a blanket process. Alternatively, transactions that contain an actual policy number apply to that policy only. The zero-level transaction may be the only transaction ever generated. An example is a traditional group term insurance billing transaction, where the amount of insurance for the entire group is billed at a single per unit rate. This transaction contains the fictitious policy number zero. At the opposite extreme, an individual transaction is generated when the transaction is originally scheduled for an insurance premium billed directly to the insured. This transaction contains the actual policy number for the policy involved.

Alternatively, a zero-level scheduled transaction might be generated for a group of directly billed individuals all of whom are due to be billed on the same date for the same type of coverage. Then an intermediate summary level transaction, containing the per unit premium rate, might be generated for the group for each rating age at the time the transaction is moved from the scheduled queue to the pending queue. An individual transaction might then be generated for each policy at the time the intermediate transactions are processed. In this example, the scheduled transaction contains only that information applicable to the entire group and acts as a template for creating the intermediate level transactions. Thus information common to all transactions does not need to be retrieved repeatedly. The intermediate level transactions then serve as templates for creating the individual transactions and the rates included when they are created need be retrieved only once.

The system is more efficient because fewer transactions are in the queues and other tables need be accessed far less frequently. If there are 1,000 members of the group, only one transaction is placed in the scheduled queue and about 50 are placed in the pending queue, rather than placing 1,000 transactions in each of these queues. This system also better adapts to changes. In the above example, if the rates are changed after the intermediate level transactions have been created, but before they are processed, only a few template transactions have to be voided and recreated, rather than many individual ones.

In another example, when most transactions for a group contain the same information with only a few exceptions, a zero-level transaction can be scheduled for the group with additional individual transactions scheduled for the exceptions. These related transactions are tied together by a common key counter. Daily cycle 108 will then recognize that the information in the zero transaction applies to all the members of the group except those for which individual transactions are present. If there are 1,000 members of the group and 25 are exceptions, only 26 transactions need be created, rather than 1,000. Thus the system is more efficient in not requiring that a transaction be created for each individual whenever there is any variation.

Executed transactions that require reconciliation or confirmation, step 164, are moved to the awaiting queue where they are either reconciled or confirmed as appropriate, step 166. Once the reconciliation is complete of confirmation is received, the transactions is released. Step 168. The master and trailer data generated during the transaction is then stored in the master and trailer tables, respectively, step 158, and the transactions are moved to the history tables, step 160.

Transactions that are unsuccessfully scheduled, upgraded to a pending status, or executed are moved to the suspense queue and flagged with an error. Step 170. Transactions in the awaiting queue that are not successfully reconciled or confirmed are also moved to the suspense queue and flagged with an error. Step 172. A transaction is unsuccessful if tables, rules or data required to execute the transaction is not available in the computer system 100. A user can then read the error and either void the transaction or correct the problem that caused the transaction to be unsuccessful and submit the transaction for reprocessing. Step 174. Any voided transactions are also stored in the history tables.

FIG. 4 illustrates the process of generating and processing transaction records, master records, and trailer records customized to a predetermined level of detail. As discussed above, daily cycle 108 initially reads the scheduler breeder table and determines which transactions need to be generated and placed in the scheduled queue. Step 176. Daily cycle 108 also reads a cross-reference table entitled xTransactionGenerationMethods 178 to determine the type of the method that should be used for generating the transactions, step 180, and a method table entitled vTransactionGenerationMethods 182 to determine the level at which the transaction should be generated and processed, step 184.

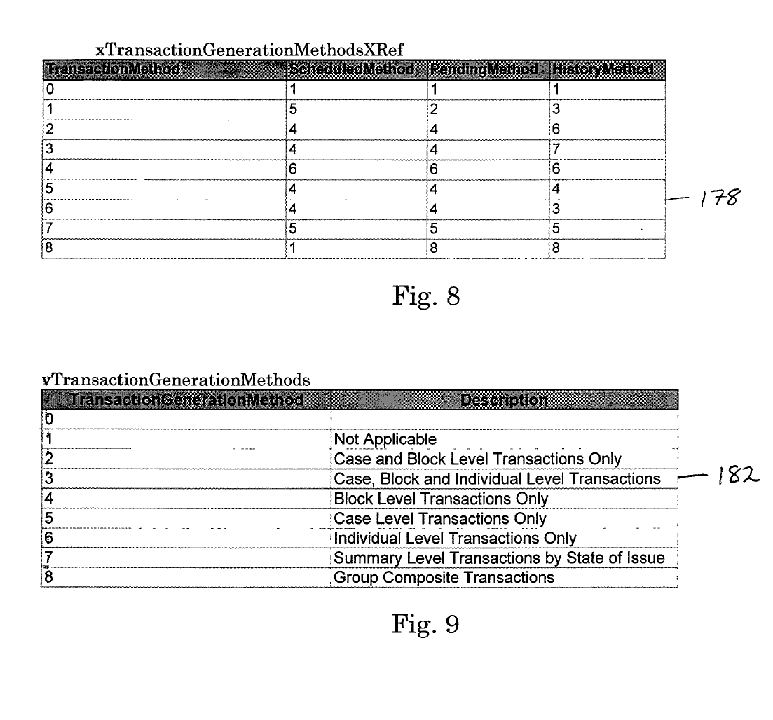

Referring to FIGS. 8 and 9, the xTransactionGenerationMethods cross-reference table 178 includes records that contains the label fields identifying the type of transaction method. Each record contains a field that contains the code identifying the method for processing transactions placed in the scheduled queue, a field that contains the code identifying the method for processing transactions placed in the pending queue, and a field that contains the code identifying the method for processing transactions placed in the history tables.

Additionally, the xTransactionGenerationMethods cross-reference table 178 is associated with a method table that is entitled vTransactionGenerationMethods 182. Each record in this method table has a field that lists a method code used in the cross-reference table and a field that identifies the execution method associated with the code. These method codes include: 3, which identifies a transaction that is to be processed at the case, block and individual levels; 4, which identifies transactions that are to be processed at the block level only; 5, which identifies transactions that are to be processed at the case level and results in one record being generated for the entire case; 6, which identifies transactions that are to be processed at the individual level only; and 7, which identifies transactions that are to be processed at the summary level by state. A block is a convenient subdivision of records within a major group.

Referring to TransactionMethod 1 in FIG. 8, transactions are generated and placed in the scheduled queue at the case level; placed in the pending queue at both the case and the block levels; and are processed and archived in the history tables at the case, block, and individual levels. Assuming this transaction contains financial information, this procedure will result in an aggregate case level history record containing totals for the entire group, intermediate aggregate level history records containing subtotals for each block within the group, and a record for each individual within the group containing the amount for that individual.

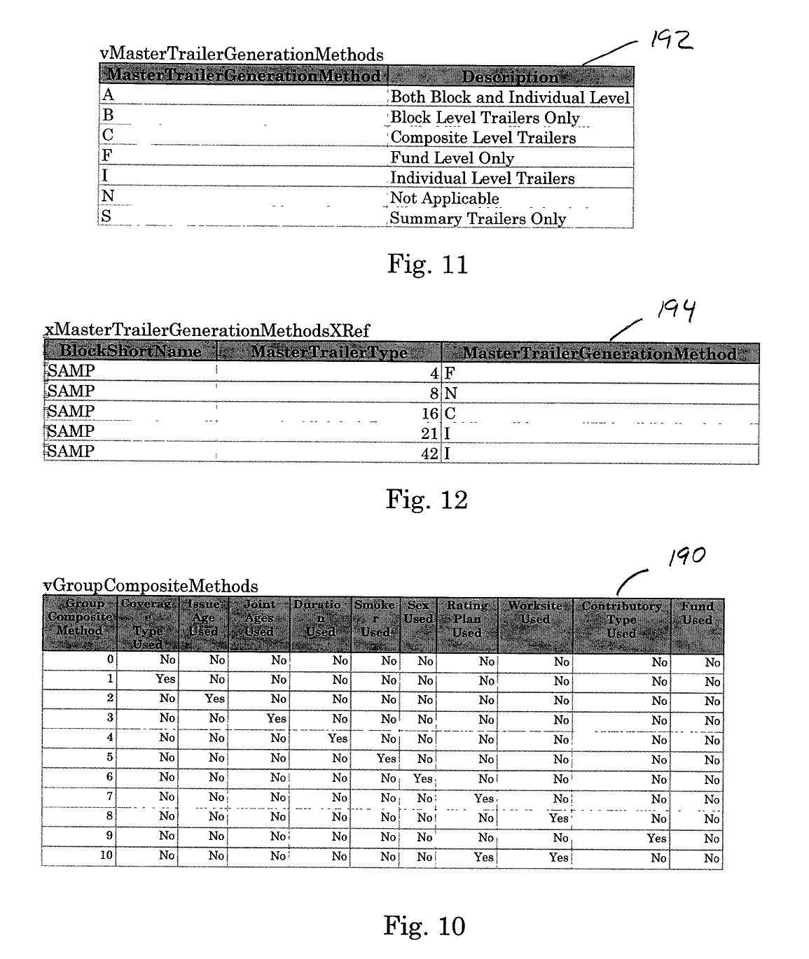

Returning to FIG. 4, if the transaction method for a given transaction is 8 or composite, daily cycle 108 reads a table to determine the group composite method, step 186, which specifies the method of compositing, step 188. The various methods are identified by group composite codes such as the numerals 1-10. FIG. 10 shows some representative portions of this table. The group composite code is referenced to a method table entitled vGroupCompositeMethods 190. Each record in this table has a field that contains the code identifying the group composite method and then a plurality of cells that contain flags indicating whether the designated method includes a particular type of compositing. For example, the method specified by group composite code 6 dictates that the criteria used for compositing is whether the insured is a smoker.

Referring to FIGS. 4 and 11, daily cycle 108 also reads a method table entitled vMasterTrailerGenerationMethods 192 to determine the default method for generating master and trailer methods. Step 189. As shown in FIG. 11, the methods for generating master and trailer methods are similar to the methods for generating transactions as discussed above.

Referring to FIGS. 4 and 12, the method for generating master and trailer information is referenced to a cross reference table, step 191, entitled xMasterTrailerGenerationMethods 194. This table is used to override a default method of generating master and trailer information, step 193, by creating a record that identifies the master or trailer type for a given block. For example, the block identified as SAMP designates that information in the Buy/Sell trailer table 4 is kept by fund, no information is kept in the Dividend trailer table 8, individual records are kept for the Miscellaneous trailer table 21 and the Policy master table 42, and a composite record is kept for the Insurance Costs trailer table 16.

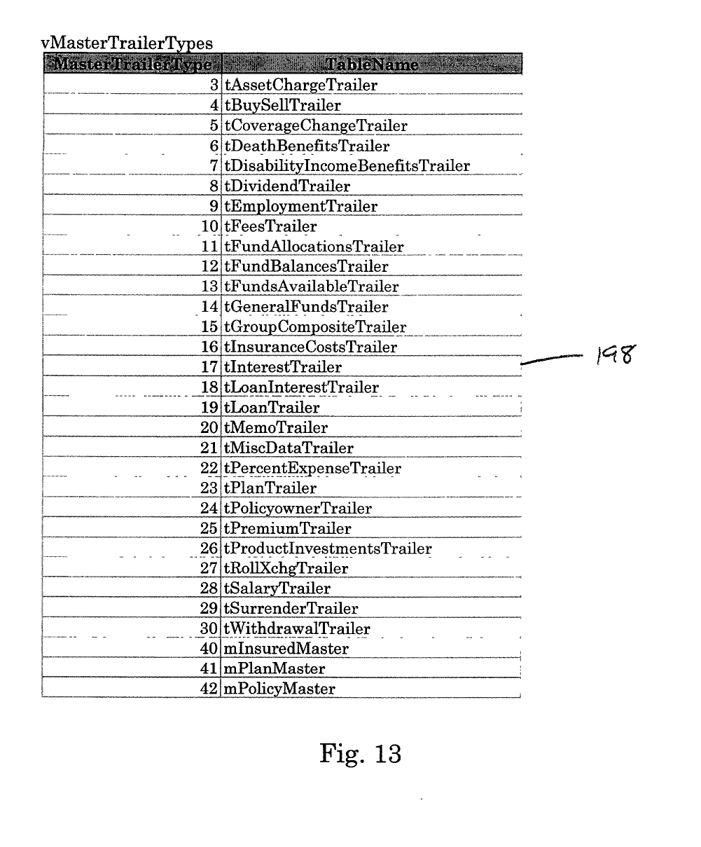

Additionally, the method of generating master and trailer information can be overridden for certain master and trailer tables. If a user attempts to override the method, availability of the selected master and trailer tables is verified by reference to a validation table entitled vMasterTrailerTypes 198. Step 196. The vMasterTrailerTypes, table 198 is illustrated in FIG. 13 and includes records that identify the master or trailer tables for which the method of generating information can be modified from the default setting and the name of the table.

Daily cycle 108 also calls various processors to perform the calculations designated by the various rules as well as read and write data to the master and trailer tables. Step 200. Depending on the programming language used, the processors can be routines, objects, or cases that are invoked by daily cycle 108. These processes also write a generated transaction into the scheduled queue, step 202, move a transaction from the scheduled queue to the pending queue, step 204, and archive the transaction in the history tables, step 206.

Another task performed by the processes called by daily cycle 108 is to write data to the master and trailer tables in accordance with the default master trailer generation method specified, unless the default method is overridden for specific tables as outlined above. Step 207. Referring to FIG. 5, some transactions result in adding new records to tables, such as Transaction Events: 91, Policy Issue—Original; and 159, Set Up New Block. Other transactions change existing records, such as Transaction Events: 57, Increase Face Amount; 59, Smoker Status Changed to Non-smoker; 72, Name Change; and 197, Employment Termination. Some such transactions, such as 59, may have a number of child transactions that also cause the master and trailer tables in the third tier to be changed. Some transactions do not change these tables. Examples of transactions that do not cause master and trailer tables to change are Transaction Events 95—Loan Value Quote; 123—Pending Claims Exhibit; and 146, Account Balances Report. The names of some third tier tables, which are indicative of their contents, are shown in FIG. 13 in the column labeled TableName.

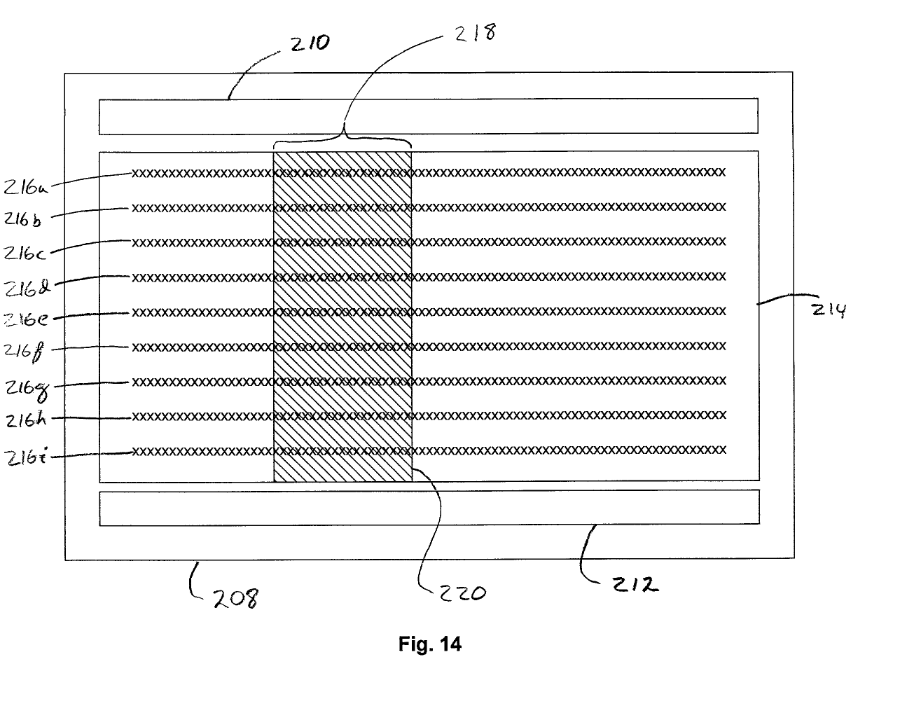

Referring back to FIG. 1, the parsing engine 110 permits an operator at a workstation 106 to identify, define, and either extract data from or write data to an external source file. The external source file can have a variety of formats such as a flat file, which is an electronic textual file, a spread sheet, or an ODBC (Open DataBase Connectivity) compliant database. Referring to FIG. 14, the parsing engine 110 has an interface 208 that includes a tool bar 210, a status bar 212, and a display area 214 in which multiple rows 216 of data are displayed in a flat file, by way of example. Each row 216 of data forms a record. Additionally, each row or record 216 includes a plurality of fields 218 into which the data is organized. Identical fields for each record are aligned in columns.

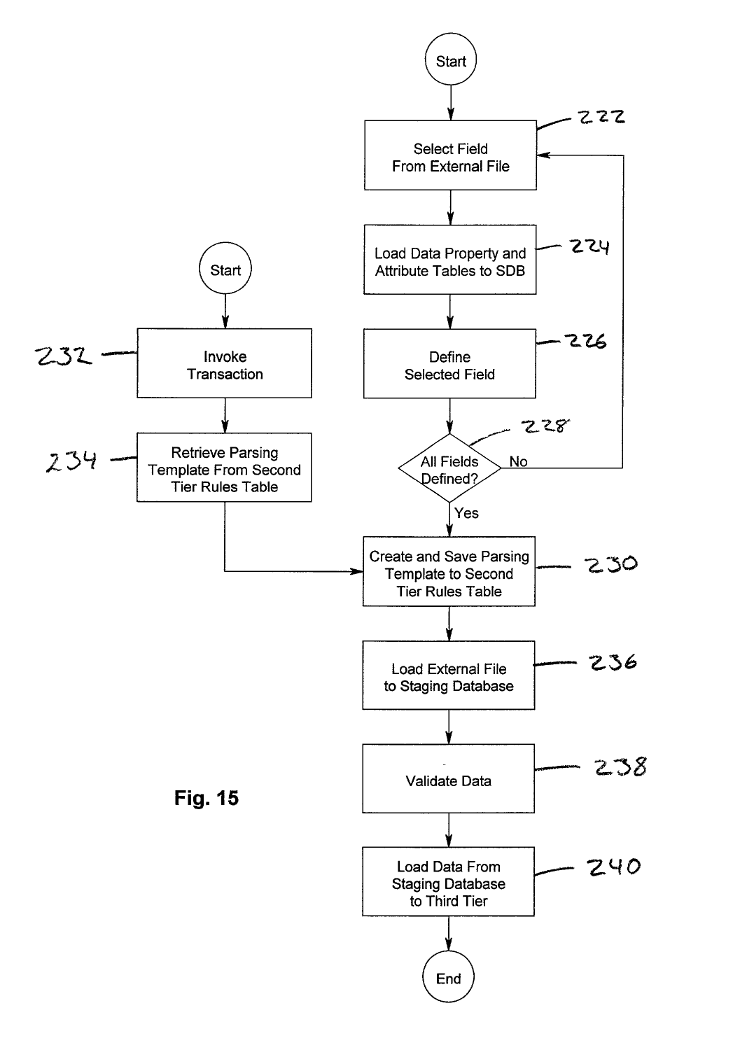

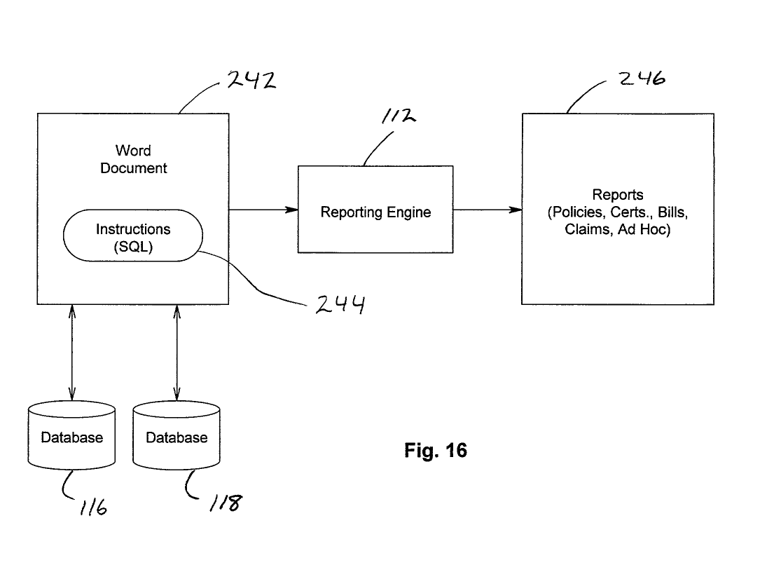

In operation, referring to FIG. 15, an operator can select a field, step 222, by swiping a mouse across the desired field 218 in one of the rows 216, which selects all of the corresponding or like fields from all of the other records in the external file. The parsing engine 110 then creates a lens 218 that highlights all of the corresponding fields 218 in the external file. The lens 220 extends from the first record 216u shown in the display area to the last record 216I shown in the display area. If the operator scrolls through the external files, as one record is removed from the display area 214, another record is shown in the display area 214, and the corresponding field within the newly displayed record becomes highlighted by the lens 220. The lens 220 gives an operator the ability to scroll through or browse the entire set of source data in the external file.

The operator defines the field 218 by selecting the type and format of the selected field. Step 226. The definition can be determined either before or after the field 218 is selected. The operator defines the selected field 218 by choosing the type and format of the selected field 218 by actuating a button on the tool bar 210 that causes a dialog box to appear on the screen. The dialog box lists the possible definitions according to the rules in the data property and attribute tables. As discussed above, these tables and the corresponding rules are loaded into the scratch database of the workstation as described above. Step 224. Once all of the fields for the external source files are defined, step 228, the operator clicks a button on the tool bar to save the set of definitions in a template, step 230, which is a set of rules placed in a structure table in the second tier 103. In the future, an operator can then invoke a transaction, step 232, to recall the template, step 234, for importing data from similar external files.

The structure file is written to the second tier 103 at the time the structure is first identified. Once the structure is known, it is not necessary to perform the parsing process again unless the structure changes. The data being imported to the third tier is first stored in the staging platform database 120. Step 236. A transaction (or transactions), is created to add to or update the third tier data using the data from the staging platform 120. As the transactions are processed, the benefit data is verified, step 238, to ensure that it conforms with all of the relevant data validity and other rules before it is written into the third tier 104, step 240.

Once a template exists for a particular format of external file, a transaction is created and executed to extract data from the-specified external source according to rules specified in a structure table as generated though the user interface 208 portion of the parser 110. This transaction may be generated through user input, or as a regularly scheduled transaction. An example of the user input transaction is the import of an initial employee census. An example of the regularly scheduled transaction is the import of information from monthly tapes from an employer's payroll system.

In addition to importing data into the computer system 100, the parsing engine 110 can export benefit data from the computer system 100 to an external file. Exporting is accomplished by reversing the import process and using a rules template to determine the relationship between the benefit data in the third tier that is selected for exporting and the format of the external file.

The parsing engine 110 has several advantages. For example, programming intervention is minimized as new external data sources and targets are introduced to the system. Because this process does not normally involve any new programming, administrative users can perform functions usually requiring a programmer's intervention. As a result, faster and better service can be provided to customers at a lower cost. Additionally, external definitions can be stored and re-used indefinitely. Data import confidence is enhanced by the visual interface, which provides a view of all the data in a given source, and data integrity verification is provided on multiple levels through the use of the parsing templates and the data validation rules.

If sufficient information is given by the external source, the structure table can be created by a first tier workstation 106 and submitted to the system through a transaction. Such transactions can be executed immediately. The operator can then select the structure and use the parser 110 to view the data being imported or exported, if desired.

The computer system also includes a FORMS process of displaying information to users. The process provides a standard of presenting data on panels for entry, edit, or review. All FORMS panels are MDI (Windows Multiple Document Interface) child panels, i.e., they are always presented in a MDI parent form. The mode of presentation is similar to a window into the tables.

Using the FORMS process, child panels are constructed based on the architecture of a record set, which is the result of an inquiry or query of a database. The fields, or individual pieces of data, in the record set are displayed in individual standard controls on the child panel. A control is a position on a panel which holds/shows a piece of data. All FORMS compliant panels are constructed in exactly the same way, where different types of data fields such as dates, text, numbers, and pick lists are accommodated with a field-appropriate control. When the program is called upon to present one of these panels, it invokes a series of routines that put the values into the controls, does high-level validity checking, and enables editing. Pick lists are always populated from rules from lookup tables in the second tier 103. This is accomplished by using the system's proprietary routines that manipulate customized properties of the pick list control. In effect this methodology provides an extremely flexible bound control. A bound control is a control that is related by rules to a field in a table of a database.

There are other standards. For example, control navigation buttons are always in the lower right hand corner of the screen in a frame, lists always appear on the upper part of the panel with drill down detail appearing beneath them, and discreet picks such as state codes always appear in a pick list. In this situation drill down data is the entire set of fields of a record represented in a list.

The FORMS process has several advantages. For example, all FORMS compliant panels look substantially similar. The standard gives a streamlined look and feel to the software as every system function looks familiar. Training is simplified as more energy can be spent on training for function rather than navigation. It also minimizes the amount of time necessary to create new panels or do ongoing maintenance as new tables, fields or other changes to the data architecture occur.

Referring now to FIGS. 1 and 16, the reporting engine 112 is located in at least one of the workstations 106 and permits an operator at the workstation 106 to create reports 246. The reporting engine 112 uses a word processor and spread sheet such as Microsoft Word™ and Microsoft Excel™, as a conduit for generating reports.

References to the reports, including the locations of templates and report descriptions, are stored in rules tables. Templates for reports are represented by electronic documents 242 stored as rules in the memory of the second tier. Each template includes all of the information needed to generate the report, including the format, margins, fonts, positioning, paper size, orientation, graphics, other visual characterizations of the report, and any preset text.

In addition to preset text, the body of the electronic document 242 is imbedded with the system's ANSI standard SQL language 244 (Structured Query Language), which is extended with tags that refer to the rules in the second tier and provides instructions on how a record set is created. The record set created by the SQL includes either the fields defining the information to retrieve from the third tier 104 or rules that define calculations that need to be made using benefit data from the third tier 104. An example of information to be retrieved might be the names and policy numbers of insureds for which a list billing report is being generated. An example of a calculation might be to sum up the amounts from such a billing report and insert the total into the report.

When generating a report 246, the reporting engine 112 first reads the template document 242 that identifies the report and its various parameters. The template 242 is read by invoking the OLE automation services of Microsoft Windows™. OLE is an object linking and embedding standard that provides a means for sharing information and components between different programs. The reporting engine 112 then interprets and executes the SQL language 244 imbedded in the electronic document 242 to generate a record set. Next, the reporting engine 112 inserts data as defined in the embedded SQL language into the report document by interpreting bookmarks or named ranges along with their associated field references. If the report is a Microsoft Word™ document, bookmarks are referenced. If the report document is a Microsoft Excel™ spreadsheet, named ranges are referenced. The reporting engine also will use any rules referenced in the template document to generate any necessary calculations.

As described above, the system tables, report templates and the required rule tables, and the required benefit data that have been extracted are downloaded to the scratch database 114 for the workstation 106 where the report 246 is being generated. Additionally, the operator can save, print, or electronically transmit the report 246. Once the report template 242 has been saved, an operator or a client process invokes generation of the report 246 by submitting a transaction, in which case any necessary parameters (variables) are automatically sent to the reporting engine 112 as information contained in the transaction. Such transactions can be executed immediately. Reports 246 can also be generated on an ad hoc basis where variables are detected and interpreted from the SQL extensions, and presented on a FORMS compliant panel for the user to select. A transaction is created as a part of this ad hoc process.

The report engine 112 has many advantages. For example, the need for intervention by a programmer, and consequently user/developer communication with the programmer, is virtually eliminated as new reports are introduced to the system. Reports can be designed by any operator of the computer system who can use a word processor or spreadsheet to meet their needs and to conform with formatting they desire. In fact, electronic documents 242 including the SQL can be created entirely by operators with a minimum of training. Reports can be electronically archived as discussed above in more detail, without going through manual steps. This archiving can be dictated through the parameters of a transaction. Another example, is that the computer system 100 can provide customized fields that are invoked by the SQL in the electronic document 242, whereas standard fields had to be used in traditional embodiments. Thus, customized reports can be generated without the need to create entirely new documents and queries.

If reports that have previously been stored as rules templates are modified, the old version is automatically archived to history. Thus, it is always possible to recreate an old report if needed, and the system has an audit trail for changes in reports.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

The claimed invention is:

1. A computer system for administering employee benefits, the computer system comprising:
a first tier, the first tier including a plurality of users, at least one user being a workstation having a processor and memory, and at least one other user being system processing means, wherein
a) the workstation is configured for inputting rules into the computer system, the rules for controlling the computer system; and
b) the system processing means is configured to generate and execute transactions based upon the rules;
a second tier, the second tier including memory, the memory configured to store the rules, the rules being organized into tables; and
a third tier, the third tier including memory, the memory configured to store benefit data, the benefit data being organized into tables, wherein the benefit data can be manipulated only by the system processing means executing the rule-based transactions.

2. The computer system of claim 1 wherein:
the workstations in the first tier are configured to download rules from the second tier;
at least a portion of the workstation memory is configured to form a temporary database for storing some rules for a session, the rules being downloaded from the second tier; and
the processor of the workstation is configured to erase the temporary database from the workstation memory after the session is complete.

3. The computer system of claim 1 wherein the system processing means is further configured to select rules from the second-tier memory and organize the rules into transactions.

4. The computer system of claim 1 wherein the system processing means is configured to automatically:
load generated transactions into a queue, the transactions being scheduled for execution at a predetermined time;
scan the queue for transactions scheduled for execution at a predetermined time; and
execute the scheduled transactions at the predetermined time.

5. The computer system of claim 1 wherein the transactions loaded in the queue are configured to access benefit data from the third tier, and the system processing means is further configured to:
verify validity of scheduled transactions and availability of benefit data required to execute scheduled transactions;
generate an error when required rules or benefit data is not available; and
place scheduled transactions which fail into a suspended state.

6. The computer system of claim 5 wherein the system processing means is configured to remove a scheduled transaction from the suspended state when all of the required rules are validated and benefit data is available and the error is cleared.

7. The computer system of claim 1 wherein at least some of the rules are data attributes and the first tier further includes a parsing engine, the parsing engine being configured to:
generate rules for conforming data to the format of the import file; and
generate rules for conforming data in the format of the import file to the format of benefit data stored in the third-tier memory based upon the data attributes.

8. The computer system of claim 7 wherein the import file has a plurality of records, each record having discrete portions corresponding to data attribute rules, the parsing engine being configured to:
generate a user interface, the user interface having a portion configured to display at least some of the records, each record having a plurality of fields, corresponding fields for each record being organized into columns; and
select and highlight a field.

9. The computer system of claim 7 wherein the parsing engine is further configured to:
import data from an import file to the third-tier memory;
format data from the input file to conform to data attribute rules;
export data from the third-tier memory to first tier memory; and
format data from the third-tier memory to conform to data attribute rules.

10. The computer system of claim 1 wherein the first tier further includes a reporting engine, the reporting engine being configured to:
load a word-processing document;
embed rules within the document for selecting data from the third tier;
embed rules within the document for conforming data to the format of a report; and
store such rules in the second tier.

11. The computer system of claim 10 wherein the third tier has a plurality of tables, each table having a plurality of records, each record having a plurality of fields, the reporting engine being configured to generate a document, the document having a portion configured to display at least some of the fields from some of the records from some of the tables.

12. The computer system of claim 10 wherein the reporting engine is further configured to:
export data from the third-tier memory to the first tier in conformance with rules;
format data from the third tier to conform to rules; and
generate a report to a word-processing document.

13. The computer system of claim 1 wherein the tables in the third tier include on-line history tables and rules in the second tier include history rules, the history rules including:
a first set of rules that define which benefit data from a particular table should be archived to the on-line history tables;
a second set of rules that define when benefit data is archived to the on-line history tables; and
a third set of rules that define what benefit data from a predetermined identifying key is archived to the on-line history tables.

14. The computer system of claim 13 further comprising means for writing data to an external storage medium, the external storage medium being configured to store an off-line history table, the rules in the second-tier further including:
a first set of rules that define which benefit data from a particular table should be archived to the off-line history tables;
a second set of rules that define when benefit data is archived to the off-line history tables; and
a third set of rules that define what benefit data from a predetermined identifying key is archived to the off-line history tables.

15. A method of operating a computer system for administering benefits, the computer system having first, second, and third tiers, the first tier including users, the second tier storing rules, the rules being organized into tables, the third tier storing benefit data organized into tables, wherein benefit data in the third tier can be manipulated only by execution of a transaction, the transaction being formed from rules, the method comprising the steps of:
selecting a plurality of rules from tables in the second tier;
organizing the selected rules to form the transaction; and
executing the transaction, wherein execution of the transaction causes manipulation of benefit data in the third tier.

16. The method of claim 15 wherein each transaction has a predetermined execution date, the method comprising the additional steps of:
placing the transaction in a scheduling queue a predetermined amount of time before the predetermined execution date;
moving the transaction from the scheduling queue to a pending queue; and then executing the transaction on the predetermined execution date;

17. The method of claim 16 wherein the transaction is a template used to generate additional transactions, the method further comprising the steps of adding additional rules to the transaction during the step of moving the transaction from the scheduling queue to the pending queue.

18. The method of claim 16 wherein the transaction is a template used to generate additional transactions, the method further comprising the step of adding additional rules to the transaction during the step of executing the transaction.

19. The method of claim 16 wherein the transaction is a template configured to consolidate two or more transactions, the method further comprising the step of adding additional rules to the transaction during the step of executing the transaction.

20. The method of claim 15 wherein the step of executing the transaction manipulates benefit data, and the step of executing the transaction includes the step of adding additional rules to the transaction, the additional rules defining the level of detail at which the manipulated benefit data is stored in the third tier.

21. The method of claim 20 wherein the manipulated benefit data is stored in first and second tables, and the level of detail at which the benefit data is stored in the first table differs from the level of detail at which the benefit data is stored in the second table.
